(19) United States
(12) Patent Application Publication
(10) Pub. No.: US 2004/0148113 A1
(43) Pub. Date: Jul. 29, 2004

(54) Determination of leakage and identification of bursts in a pipe network

(76) Inventor: Paul Sage, Warrington (GB)

Correspondence Address: MICHAEL BEST & FRIEDRICH, LLP, 100 E WISCONSIN AVENUE, MILWAUKEE, WI, 53202, US

(21) Appl. No.: 10/469,320

(22) PCT Filed: Mar. 1, 2002
(86) PCT No.: PCT/GB02/00869

(30) Foreign Application Priority Data
Mar. 1, 2001 (GB) 0105183.8

(51) Int. Cl. G01L 7/00

(52) U.S. Cl. 702/51

(57) ABSTRACT

A method of dividing the total leakage losses of a pipe network into intrinsic background leakage and burst leakage, the method comprising: defining a first infrastructure condition factor (ICF) which is a numerical representation of the condition of a network in a threshold good condition in which intrinsic background leakage can assumed to be a negligible proportion of the total network leakage losses; defining a second ICF which is a numerical representation of the condition of a network in a threshold poor condition in which intrinsic background leakage dominates total leakage losses; deriving a network ICF for the network under consideration which expresses the condition of the network as a numerical fraction of the difference between the first and second ICFs; determining total leakage losses from the network by performing a network analysis on the network; and multiplying the total leakage losses by the network ICF to divide the total leakage losses into intrinsic background and total network burst leakage.

The present invention relates to a method of estimating the leakage levels and distribution within a network of fluid conduits enabling improved identification of likely burst sites. Particularly, but not exclusively, the invention provides a method of identifying the most likely sites of bursts in a water supply pipe network and improving the calibration of a computer model of the network.

There is a well recognised need to reduce the level of leakage from water supply networks. For instance, during a drought in the UK in 1995 (resulting in water restrictions affecting approximately 40% of the population) it was found that some 30% of water supplied to distribution systems was lost through leakage. Although in the UK this figure has now been reduced to around 20%, further improvement is necessary. As overall leakage levels reduce the relative cost of identifying remaining leaks increases. There is therefore pressure to increase the efficiency and effectiveness of leakage detection techniques.

It is now conventional to use computer modelling in the design and operation of pipe networks. For instance, computer models of water mains networks are commercially available which provide a mathematical model of the physical properties of the network. Typically such a model will identify each pipe and other network elements (such as valves, pumps etc), giving the size, material and age etc (where this information is known) all of which may have an effect on performance of the network. Where precise details of pipe elements are not known assumptions may be made.

A water mains network will typically be divided into a number of separate district meter areas (DMAs) which will be separately modelled within the network model as a whole. A typical network will have half a dozen or so DMAs each having a designated source, which may be a real source such as a surface reservoir, a pseudo-source such as a trunk main, or a source located further back upstream on trunk mains (with the DMA being supplied via a branch mains off the trunk main).

Within the network, and within each DMA, the network model will identify “nodes”. The concept of nodes will be familiar to those skilled in the art of pipe network analysis. Nodes are designated by the network model builder, or the original geographical survey of the physical network on which the model is based, and include such things as pipe junctions, pressure points, and demand points (typically models for residential areas will have 20 to 30 houses allocated to each node). The points where individual service pipes for single properties branch from the network would not generally be considered as network nodes, although there may be exceptions to this (for instance for models that cover sparsely populated rural areas).

The information provided by a network model can be used in the analysis of the performance of the network. Software packages are commercially available which can perform a hydraulic analysis on a network model providing information on a number of properties such as pressure gradients, flow directions, flow rates etc. the core of such programs is a mathematical solver often referred to as a “hydraulic engine”. In addition to the hydraulic engine the software will also include a front end to interface with the user, a back end and appropriate additional modules such as display, graph and import/export engines. Such software packages will hereinafter be referred to as “network analysis tools”.

One important step in the construction of a network model is “calibration” of the model to ensure that predicted pressures, flow rates etc correspond to actual measured values. During calibration, measurements may typically be taken from a dozen or so data loggers distributed around a DMA. Once a network model has been properly calibrated it is possible to derive overall leakage losses using well-documented methods based on the predictability of user behaviour. For instance, typical demand levels for a collection of domestic properties in the middle of the night can be accurately predicted so that if a flow meter measures greater flow than expected the difference can be attributed to leakage losses (which may be either intrinsic background leakage, bursts or both).

It is also conventional to allocate intrinsic background leakage losses to nodes across a network on the basis of the demand at those nodes. For instance, for a node in a domestic area, leakage losses are deemed to increase with the number of properties as a result of the increased number of supply connections etc from which losses can occur. Alternatively, for a rural area, the length, (or more typically half lengths) of mains may be summed up and attributed to their nearest respective model node. Thus, in the calibration of models by conventional network modelling methods overall leakage is determined from the multiple calibration flow measurements and then attributed to respective nodes around the network on the basis of demand allocated to that node.

The present invention provides an improved method of determining leakage losses on the basis of information provided by conventional network model hydraulic analysis techniques. In particular, the invention provides a method of determining what proportion of the overall leakage loss from a network can be attributed to background leakage as opposed to burst leakage, a method of predicting the likely locations and sizes of bursts within the network (giving rise to the estimated burst leakage levels), and a method of allocating background leakage to nodes according to a network.

The various aspects of the present invention can be implemented in computer software either as an integral part of a network analysis tool (such as mentioned above) or as a discrete module which can be added to existing network analysis software to provide enhanced functionality.

As will become apparent, the invention has a number of novel aspects which are combined in preferred embodiments but which can also be utilised independently.

According to a first aspect of the present invention there is provided a method of dividing the total leakage losses of a pipe network into intrinsic background leakage and burst leakage, the method comprising:

defining a first infrastructure condition factor (ICF) which is a numerical representation of the condition of a network in a threshold good condition in which intrinsic background leakage can assumed to be a negligible proportion of the total network leakage losses;

defining a second ICF which is a numerical representation of the condition of a network in a threshold poor condition in which intrinsic background leakage dominates total leakage losses;

deriving a network ICF for the network under consideration which expresses the condition of the network as a numerical fraction of the difference between the first and second ICFs;

determining total leakage losses from the network by performing a network analysis on the network;

and multiplying the total leakage losses by the network ICF to divide the total leakage losses into intrinsic background and total network burst leakage.

According to a second aspect of the present invention there is provided a method determining the most likely size and location of bursts in a pipe network, the method comprising:

determining the total burst leakage associated with the network by network analysis on a model of the network;

generating a first generation of bursts populations in each of which the total burst leakage is distributed amongst nodes of the network model;

performing a network analysis on the network model for each of the burst populations, the network analysis being conducted in each case on the basis of the respective distribution of bursts across the network;

comparing operating parameters of the network determined by the network analysis for each burst population with measured values of said operating parameters to determine a best fit burst population for which the operating parameter values determined by the network analysis best match the measured values;

generating second and subsequent generations of burst populations, the distribution of bursts in at least some of the burst populations of each generation being weighted in accordance with the burst distribution of the best fit population of the previous burst generation;

performing the network analysis and best fit comparison on each generation and continuing until subsequent generations show no significant improvement in best fit burst population.

According to a third aspect of the present invention there is provided a method of allocating intrinsic background leakage across the nodes of a pipe network model, the method comprising:

determining the total background leakage of the network;

determining the user demand at each node of the network;

determining a nodal infrastructure condition factor (ICF) for each node representative of the relative condition of each node;

dividing the demand associated with each node by the nodal ICF of that node to derive a nodal leakage factor (LF);

and multiplying the nodal LF by the total background leakage for the network and dividing by the sum of the nodal LFs of all nodes within the network to determine the background leakage to be allocated to that node.

Additional preferred and advantageous features of the various aspects of the present invention will become apparent from the following descriptions.

Specific embodiments of the present invention will now be described, by way of example only, with reference to the accompanying drawings in which:

The examples of the various aspects of the present invention which will now be described require a computer model of the network (or part of the network concerned) and other network analysis tools (including an hydraulic engine) necessary to perform calculations and predictions on the basis of the network model (i.e. network analysis including hydraulic analysis of flow pressures and rates etc). Since the present invention may be implemented as a discrete software module which can interface with proprietary network analysis software, no detailed description of such features will be given here. Accordingly, it is to be understood that in a practical computer system for operating the various aspects of the present invention as described below the invention will operate as part of a system additionally. comprising a computer model of the network under consideration, a hydraulic solving engine for performing hydraulic calculations and predicting the effect of changes to the network, and suitable interface and reporting facilities. The nature of the additional software analysis tools required will be readily apparent to the skilled reader by reference that are made to the required functionality. Such additional software tools may be entirely conventional and thus no description of appropriate tools will be made apart from references to the required functionality.

In the following description reference will be made to operations performed on a pipe “network”. It is to be understood that this term may refer to a complete network, or to only part of a network such as a DMA. The term “network” is therefore is to be interpreted as referring to a modelled network or a modelled part of a network which is under consideration.

As mentioned above, conventional hydraulic analysis techniques can be used to determine the total leakage from a pipe network, typically on the basis of the difference between expected demand and measured usage. A first aspect of the present invention is a method of dividing the total leakage losses from the network (obtained by conventional techniques) into intrinsic background leakage and burst leakage.

The allocation of total leakage between burst and background leakage in accordance with the present invention is made on the basis that the level of intrinsic background leakage is related to the condition of the pipe work within the network. The invention provides a method of determining a numerical condition factor, referred to hereinafter as “infrastructure condition factor (ICF)”, for the network which directly gives the ratio of background to burst leakage within the network. This aspect of the invention is based on two premises.

First, if a network consists entirely of pipes in “perfect” condition, any leakage from the network could be assumed to be attributable to bursts as intrinsic background leakage could be assumed to be zero. Secondly, a network can be envisaged which consists entirely of pipes at, or below, a threshold “poor” condition at which intrinsic background leakage levels will be so high that burst leakage could be regarded as a negligible contribution to the total overall leakage (even though pipes in such poor condition would also have a high susesptability to bursting).

The method according to the invention is then to express the condition of a network as a numerical fraction of the difference in condition between such “perfect” and threshold “poor” condition networks and take this as the proportional split of the total leakage between burst and intrinsic background leakage. For instance, if a “perfect” condition network for which intrinsic background leakage can be assumed to be zero is given a perfect ICF of 1, and a threshold “poor” condition network representing a low pipe level of integrity at which intrinsic leakage will become so high that burst leakage can be regarded as negligible (or indistinguishable from background) is given an ICF of zero, then a network with an ICF of 0.3, for example, will have 0.3 of its total leakage attributable to bursts and 0.7 of its total leakage attributable to intrinsic background leakage.

In more detail, the preferred method according to the invention involves first determining an ICF for each pipe and then finding an average ICF for the network taking into account the length of each individual pipe. The ICF of an individual pipe can be regarded as the proportional split of the total leakage between burst leakage and background leakage that would be expected in a network comprising pipes all having that ICF. In general the ICF should not be regarded as giving a split of burst vs. background leakage on a pipe by a pipe basis due to the unpredictability of any particular pipe developing a burst. It is only when averaged out across a network that the ICF value becomes an accurate measure of the split between background and burst leakage.

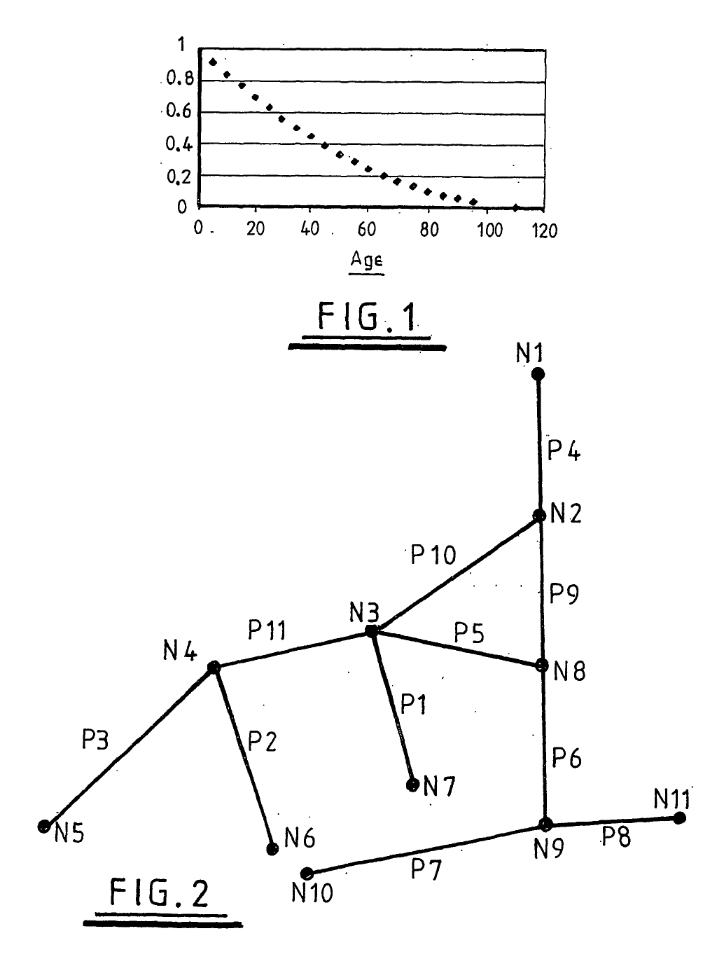

The determination of the ICF of individual pipes within a network can be derived on an empirical basis. For instance, in a typical network within the UK the condition of any particular pipe can be assumed to be a direct function of at least the age of the pipe. Therefore, in one relatively simple embodiment of the invention the ICF for a pipe can be calculated from an empirical formula expressing the ICF as a function of the age of the pipe in question. For instance, for a typical pipe supply network in the UK the general expected relationship is as illustrated in FIG. 1 which shows that the rate of deterioration within a network will decrease with increasing age. A simple empirical relationship which gives this result conveniently normalised to give a perfect ICF of 1, is:

ICF=(1−Age of pipe/Age Max)^{K}

Where the co-efficient, K, is greater than 1. In practice, a co-efficient of 1.8 has been found to give good results for a typical water supply network in the UK.

The term “Age Max” is the age at which the condition of the pipe is the threshold “poor” condition mentioned above. Engineering experience suggests that for a typical UK water supply network this should be 110 years. Thus, the ICF of a pipe will be between 0 (for the very oldest pipes) and 1 (for brand new pipes)

The ICF of a pipe determined in this way can be regarded as a condition factor per unit length of pipe since the ICF value does not itself take account of the length of the pipe. For instance, a pipe in relatively good condition may still contribute more to the intrinsic background leakage within the network than a pipe in relatively poor condition if it is of much greater length. Thus, to find an average ICF for the network as a whole in accordance with the present invention the ICP calculated as above for each pipe in the network is first multiplied by the length of the respective pipe to give length weighted ICFs for each pipe. The length weighted ICFs are them summed and divided by the total length of pipework within the network to give an average ICF for the network as a whole. This will now be illustrated by way of example with reference to FIG. 2 which illustrates a simple pipe network.

The pipe network of FIG. 2 comprises 11 pipes, P1-P11, linking 11 nodes, N1-N11. Table 1 below gives the ICF and length weighted ICF for each pipe P1-P11 calculated on the basis of the listed age and length data for each pipe and using the above empirical relationship (talking “Max Age” to be 110 years).

TABLE 1

| Pipe | Length | Age | ICF | ICF * Len |
|---|---|---|---|---|
| P1 | 200 | 13 | 0.797 | 159.482 |
| P2 | 200 | 65 | 0.200 | 40.023 |
| P3 | 300 | 8 | 0.873 | 261.875 |
| P4 | 400 | 16 | 0.754 | 301.428 |
| P5 | 600 | 70 | 0.162 | 97.13 |
| P6 | 200 | 16 | 0.754 | 150.714 |
| P7 | 3000 | 75 | 0.127 | 381.889 |
| P8 | 200 | 100 | 0.013 | 2.670 |
| P9 | 200 | 100 | 0.013 | 2.670 |
| P10 | 800 | 75 | 0.127 | 101.837 |
| P11 | 200 | 100 | 0.013 | 2.670 |
| TOTAL | 6300 | | | 1502.388 |

From table 1 it can be seen that the total length weighted ICF for the network is 1,502.388 and the total length of pipework within the network is 6,300 (the length units are not important). This gives an average ICF for the network of 1502.4/6300 which equals 0.238. In accordance with the invention, this directly gives the proportion of the overall leakage that can be attributed to bursts.

The total leakage can be determined by conventional methods. The conventional method adopted for the purposes of exemplifying the invention is that mentioned above in which overall leakage is assumed to be proportional to the number of properties (houses) allocated to each node (or as appropriate the sum of the mains half-lengths either side of a node in a rural area). In accordance with such methods it is conventional to allocate leakage in terms of “property” units which can then be converted into real flows (e.g. litres per second) once the final allocation has been made. Thus, in the following example leakage rates will be referred to in terms of properties, the actual leakage values being directly proportional to the property values.

In the simple example network of FIG. 2 there is assumed to be a total property count of 50. In other words, a total leakage of 50 properties. Thus, in accordance with the present invention the total burst leakage is assumed to be 0.238×50=11.92 properties (ie. The average network ICF multiplied by the total leakage), the remaining 38.08 properties being attributed to intrinsic background leakage.

The basic effectiveness of the above method in allocating total leakage to burst and background leakage is independent of any particular method of deriving an appropriate empirical formal for the network under consideration. Although the accuracy achieved will be linked to the appropriateness of the empirical formal applied, it will be within the skill of the skilled engineer responsible for the network analysis to provide an appropriate empirical formula which provides the necessary ranking of the condition of the pipes in the network under consideration.

Whereas the formula set out above has provided good results when applied to a typical UK water supply network it is a relatively simple formula in that, for instance, it takes no account of the pipe material other than to the extent that there is an implicit relationship between pipe age and material in a typical UK network (older pipes being made of cast iron). Thus, more detailed formula might include express terms related to the pipe material, the number of pipe joints, and other factors including ground conditions etc.

It will also be appreciated that although convenient, it is not necessary to normalise the range of ICF values between 0 and 1.

Having determined the proportion of the total leakage that can be attributed to bursts, the task remains to identify the location and size of individual bursts. Another aspect of the present invention provides a method of determining the most likely location, and size, of bursts within the network. Essentially, the invention provides a method of generating populations of burst distributions which can be compared with measured values using conventional hydraulic analysis techniques to arrive at a “best fit” population which closely matches the measured values. The “best fit” is preferably determined by comparison of the available or gauge pressures predicted by the network model to those measured at a sub-set of nodes used for calibration of the model and at which data loggers were used to accurately record pressures. The process is continued until successive generations of the predicted burst populations show no significant improvement in the best fit burst population.

In more detail, a first generation of populations of burst distributions (represented in the example by nodal property counts as mentioned above) is generated and the best fit population (i.e. burst distribution) is determined by hydraulic analysis (which may be entirely conventional). Certain information from the best fit population is then carried forward to a subsequent generation of populations to modify the generation of the burst distributions, i.e. to weight them towards the previous best fit. Hydraulic analysis is then performed on the second generation populations and the best fit population from that generation determined. The process is continued for third and subsequent generations until no significant improvement in the best fit population is made from one generation to the next. This best fit population is then taken as the solution.

To avoid the possibility of arriving at a best fit which is effectively located in a “local minima” (a term familiar to those skilled in the art of genetic algorithms of this type), it is preferable to introduce a random element into each generation of populations.

In the preferred manner of operating the invention, each population of burst distributions is generated, and tested, on the basis of the following basic steps:

i) Bursts are allocated to a number of the nodes of the network under consideration. The number of nodes to which bursts are allocated can be anything from zero to the total number of nodes under consideration.

ii) The total amount of burst leakage is allocated between at least the nodes at which a burst is deemed to be located from step (i).

iii) A hydraulic analysis is performed to determine the difference between the measured available pressure head values for the network and those available pressure values predicted on the basis of the proposed burst distribution determined on the basis of steps (i) and (ii).

Having completed the above process for each population in a given generation, the best fit population is determined. This may for instance be determined by summing the differences between the measured pressure head values and those predicted on the basis of the burst distribution of a respective population, the best fit population being that with the lowest total difference.

Once the best fit population of a given generation is determined, information from that population is carried over into at least some of the population members of a subsequent generation of burst populations. That is, information representing the relative sizes of the bursts allocated to nodes in accordance with the best fit population is used to weight the distribution of burst leakage amongst nodes in the generation of at least some of the burst populations of the subsequent generation.

In a preferred embodiment of the invention the distribution of burst leakage in each generation of burst populations (including the first population) is also weighted in accordance with a factor representative of the condition of each node. Preferably this is an average nodal ICF determined on the basis of individual pipe ICFs calculated as mentioned above. The weighting of the burst leakage distributions in the populations of a subsequent generation is then achieved (at least in part) by adjusting the ICF of appropriate nodes on the basis of the best fit information from the previous generation. That is, the nodal ICF value is adjusted to represent an increased likelihood of the existence of a burst, in proportion to the relative size of the burst allocated to that node in the previous generations best fit population.

Also, in preferred embodiments of the invention, the condition factor, or modified condition factor (as the case may be), is used both to weight the initial allocation of bursts to nodes and the size of the burst allocated to a node.

A preferred approach to applying this particular aspect of the invention to identify bursts sites and sizes in a network will now be described by way of example based on the simple network of FIG. 2.

In this example the objective is essentially to determine an allocation of bursts to nodes which a hydraulic analysis shows to be a close fit with the measured values. In each generation of burst distribution populations the likelihood and size of a burst appearing in a particular node is weighted in accordance with an average condition factor determined for that node. Thus, a preliminary step of the preferred method is to determine an average ICF for each node under consideration. In addition, to perform the hydraulic analysis on each population within each generation it is also necessary to distribute the total background leakage across the network. Whereas this may be done in accordance with conventional methods, a preferred method is provided by the present invention.

The average nodal ICF is basically calculated in the same way as the average network ICF. The length weighted ICF for each pipe converging at the node is summed and then divided by the total length of the pipes converging at that node to arrive at the average nodal ICF figure. For instance, taking node N2, the pipes converging at this node are P4, P9 and P10. Taking the pipe lengths and length weighted ICF values quoted in table 1, gives a total length weighted ICF for these three pipes of 405.9349 and a total length of these three pipes of 1,400. The average nodal ICF for node N2 is then calculated as 405.9349/1400=0.29. Table 2 below sets out the results of this calculation for each of the nodes in the network of FIG. 2.

TABLE 2

| Node | Av.ICF |
|---|---|
| N1 | 0.754 |
| N2 | 0.290 |
| N3 | 0.201 |
| N4 | 0.435 |
| N5 | 0.873 |
| N6 | 0.200 |
| N7 | 0.797 |
| N8 | 0.251 |
| N9 | 0.754 |
| N10 | 0.127 |
| N11 | 0.013 |

As mentioned in the introduction of this specification, the conventional method of apportioning background leakage across a network is to allocate background leakage to nodes within the network on the basis of demand associated with that each node. The demand at each node will typically be related to the number of houses with the node in a built up area and to the lengths or half lengths of pipes converging at a node in rural areas. Other basis for determining demand distribution may however be used. The particular method for associating demand with a node will depend on the particular network model used but whatever the method the demand distribution will be provided by the network model.

A relatively simple conventional manner of distributing background leakage across a network would be to divide the total background leakage by the total demand to give an average background leakage per demand unit (e.g. average background leakage per property) and then to multiply the demand at each node by the average figure to give an absolute figure of the background leakage associated with that node. It will be appreciated from this calculation that the unit used in the demand allocation is not relevant in the final calculation.

Within an urban model, however, background leakage is related not only to the number of service connections (i.e. typically the number of houses) it is also related to the pipes themselves and the properties associated with those pipes, such as leaking pipe joints.

The present invention accommodates the influence of background leakage from service pipes, thus improving upon the above method, by weighting the leakage associated with each node on the basis of the average nodal ICF of each node. This is done by dividing the demand allocated to a node by the average ICF of that node to obtain a factor which may be termed a “leakage factor”. The amount of background per leakage LF for the network as a whole is then calculated by dividing the total background leakage by the total summed LFs for all nodes within the network. The leakage associated with any particular node is then simply calculated by multiplying that nodes LF by the background per LF figure. In other words, the LF for each node is first calculated by dividing that nodes demand allocation by its average ICF and then the leakage for each node is derived by dividing that nodes LF by the summed LPs for the whole network to give the fraction of the total leakage which may be associated with that node. The actual leakage value is then simply obtained by multiplying the total background leakage by this fraction.

Table 3 below shows the results of the LF and background leakage calculation for each node in the network of FIG. 2 on the basis of a demand allocation (property counts) listed and on the basis of a total background leakage of 38.1 properties calculated above.

TABLE 3

| Node | Av.ICF | Demands | LF | Back. Leak |
|---|---|---|---|---|
| N1 | 0.754 | 0 | 0.000 | 0.000 |
| N2 | 0.290 | 3 | 10.346 | 1.011 |
| N3 | 0.201 | 4 | 19.938 | 1.949 |
| N4 | 0.435 | 5 | 11.492 | 1.123 |
| N5 | 0.873 | 6 | 6.873 | 0.672 |
| N6 | 0.200 | 5 | 24.986 | 2.442 |
| N7 | 0.797 | 2 | 2.508 | 0.245 |
| N8 | 0.251 | 15 | 59.877 | 5.852 |
| N9 | 0.754 | 4 | 5.308 | 0.519 |
| N10 | 0.127 | 3 | 23.567 | 2.303 |
| N11 | 0.013 | 3 | 224.713 | 21.961 |
| Total | | | 389.609 | |

Turning now to the method of determining burst location and size, tables 4 and 5 below give the results of first and second generations of pipe burst populations generated on the basis of the network of FIG. 2. In this simple example each generation comprises only three populations.

It is also to be noted that bursts are only allocated between notes N2-N8. This is because in the example the other nodes are taken to outside the domain of the measurements returned by pressure loggers and thus outside the scope of the necessary hydraulic analysis.

TABLE 4

| 1a | Order | N4 | N2 | N6 | N8 | N5 | N7 | N3 |
|---|---|---|---|---|---|---|---|---|
| | Fit | 0 | 0 | 0 | 0 | 0 | 0 | 0 |
| | ICFm | 0.435 | 0.290 | 0.200 | 0.251 | 0.873 | 0.797 | 0.201 |
| | Random1 | 0.523 | 0.352 | 0.705 | 0.431 | 0.283 | 0.624 | 0.681 |
| | IsLeak | Y | Y | Y | Y | | | Y |
| | Random2 | 0.162 | 0.285 | 0.035 | 0.017 | | | 0.343 |
| | Prob | 0.092 | 0.203 | 0.028 | 0.013 | | | 0.274 |
| | Burst | 1.092 | 2.195 | 0.244 | 0.106 | 6.015 | | 2.272 |
| | Remain | 11.924 | 10.831 | 8.637 | 8.393 | 6.015 | | 8.287 |
| 1b | Order | N8 | N6 | N2 | N5 | N7 | N4 | N3 |
| | Fit | 0 | 0 | 0 | 0 | 0 | 0 | 0 |
| | ICFm | 0.251 | 0.200 | 0.290 | 0.873 | 0.797 | 0.435 | 0.201 |
| | Random1 | 0.982 | 0.315 | 0.214 | 0.752 | 0.935 | 0.400 | 0.175 |
| | IsLeak | Y | | | | Y | | |
| | Ramdom2 | 0.970 | | | | 0.160 | | |
| | Prob | 0.727 | | | | 0.032 | | |
| | Burst | 8.669 | | | | 0.105 | 3.150 | |
| | Remain | 11.924 | | | | 3.255 | 3.150 | |
| 1c | Order | N4 | N3 | N8 | N2 | N6 | N7 | N5 |
| | Fit | 0 | 0 | 0 | 0 | 0 | 0 | 0 |
| | ICFm | 0.435 | 0.201 | 0.251 | 0.290 | 0.200 | 0.797 | 0.873 |
| | Random1 | 0.254 | 0.347 | 0.628 | 0.413 | 0.289 | 0.950 | 0.664 |
| | IsLeak | | Y | Y | Y | Y | Y | |
| | Ramdom2 | | 0.668 | 0.936 | 0.301 | 0.037 | 0.096 | |
| | Prob | | 0.534 | 0.701 | 0.214 | 0.030 | 0.019 | |
| | Burst | 1.241 | 6.369 | 3.896 | 0.354 | 0.039 | 0.025 | |
| | Remain | 1.241 | 11.924 | 5.554 | 1.658 | 1.304 | 1.265 | |

Referring to the first population of the first generation, namely population 1a identified in table 4 above, the first row, “order” sets out a randomly generated order in which the nodes will be considered.

The second row, “Fit”, sets out any weighting factor to be applied to each node on the basis of a best fit population from a previous generation. Since this is the first generation there is no weighting factor to be taken into account and thus the Fit for each node is zero.

The third row gives the value “ICFm” for each node. This is the average ICF for each node calculated as described above but taking into account any modification made on the basis of the Fit information carried over from the previous generation. Again, since this is the first generation there is no fit information and thus in each case ICFm is the same as the original calculated ICF. Thus, the figures in this row are taken directly from table 2 above.

In the fourth row a first random number, “random 1”, is generated between 0 and 1 for each node. The number random1 for each node is then compared with the ICFm value for each node to create a pseudo-random population of burst leakage distributions.

Specifically, if the value of random 1 is greater than the value of the respective ICFm a “Y” is entered in the fifth row, “Is Leak”, to designate that a burst has been assigned to that node. As is discussed in some detail above, the ICF of a pipe and of a node gives an indication of the probability of a burst occurring at that pipe or node. The lower the ICF the greater the probability of a burst occurring. As the ICFm value tends to unity, that is the pipes around the node are in best condition, there is less likelihood that Random 1 will be greater than ICFm and thus less likelihood of a burst being allocated to a node. Thus it can be seen that by comparing the ICFm with random 1 the generation of the burst leakage distribution indicated in the “Is leak” line is not entirely random as it takes into account the condition and thus likelihood of a burst occurring at any particular node. For instance, a node having a perfect ICF of 1 would never have a “Y” in the “Is Leak” column. Hence, the burst distribution is referred to as “pseudo-random”.

In the sixth row a second random number, “random 2”, is generated for each of those nodes included in the burst distribution, namely N4, N2, N6, N8 and N3. This is then used in the generation of a probability factor, listed in the seventh row, “Prob”.

Specifically, the ICFm for each burst node is subtracted from 1, the size of the remainder being directly indicative of the likelihood of a burst occurring at that node. This remainder value is multiplied by random2 to give the probability value listed the row “Prob” (e.g. for population member 1a of the first generation at node N2, Prob=(1-0.290)×0.285).

The next step is to allocate the total burst leakage amongst the nodes. The first node for which a burst is indicated in the “Is Leak” row is considered first. In population 1a this is node N4. The total burst leakage for the network as a whole is then multiplied by the probability value “Prob” for node N4 to give the burst size at that node. In this example the total burst leakage is taken to be that calculated earlier in this description, i.e. 11.92 litres per second (which is indicated in the final row of the population 1a identified as “remain” i.e. the remaining the burst leakage to be allocated). This is multiplied by the probability factor, 0.092 for N4 in this case, to give a burst leakage of 1.092 properties at N4 which is indicated in the eight row, “burst”.

The allocated burst leakage (1.092) is then subtracted from the total burst leakage figure of 11.924 to give a remainder of 10.831 litres per second burst leakage still to be allocated. This remainder appears in the “remain” row of the next node having a burst allocated to it, namely N2. Again this remaining figure is multiplied by the probability for that node, i.e. 0.203, to give a burst leakage of 2.195 litres per second at node N2. This is then taken from the remainder figure (10.831) to derive the remaining leakage to be allocated (8.637) which is carried forward to the next node in the node order indicated as having a leak and so on until all nodes indicated as having a burst associated with them are considered. The last of these in population 1a will be N3.

The above process leaves 6.015 properties of the total burst leakage unallocated. This is allocated on a random basis to one of the remaining nodes not originally indicated as having a burst. In this case the remaining burst leakage has been allocated to node N5.

Thus, the burst leakage distribution suggested by population 1a is that indicated in the “burst” row. A conventional hydraulic analysis is then performed on the basis of this burst distribution, and on the basis of a distribution of background leakage which may be determined on a conventional basis but is preferably determined on the basis of the method described above, to determine the pressure head values that would be predicted to result from this distribution of leakage. These are then compared with measured values. A sum of the total differences between the predicted and measured values is then taken to be an indication of how well the burst distribution suggested by the population fits the measured data. In other words, the lower the difference the better the fit.

The same process used to generate the burst distribution of population 1a is then used in the second and third populations of the first generation, namely 1b and 1c. Note that in each case the random order in which the nodes are considered is regenerated as are the random numbers random1 and random2. Thus, in population 1b only nodes N8 and N7 are predicted as having a burst and thus the total burst leakage is first allocated between these two nodes (on the basis of the probability factor “Prob” generated through each node) and the residual burst leakage randomly allocated to node N4.

The same process is repeated for population 1c.

Having completed the hydraulic analysis on the basis of the burst distributions suggested by each population, for the sake of this example it will be assumed that the best to fit is provided by population 1b. That is, a burst of 8.669 litres per second at node N8, a burst of 0.105 litres per second at node N7, and a burst of 3.150 litres per second at node N4. Information from this best fit population is carried forward to the next generation of populations to improve the solution. This is done in two ways.

Firstly, a “fit” value is determined for each of the nodes of the best fit population. This is a number between 1 and 0 representing the proportion of total burst leakage allocated to each node in the best fit population. Thus for node N8 the “fit” value is 8.669/11.924=0.727, the fit value for node N7 is 0.105/11.924=0.009 and the fit value for node N4 is 3.150/11.924=0.264. For all other nodes the fit value is 0 since no burst leakage was allocated to those nodes in the distribution of the best fit population 1b. The manner in which the fit value is used to influence the burst distributions allocated in the populations of the second generation will be described further below.

The second way in which best fit information is carried over from one generation to the next is to carry over the node order from the best fit population. That is, N8, N6, N2, N5, N7, N4 and N3.

Processing of the second generation of burst distribution populations will now be described with reference to table 5 below, which corresponds to table 4 above and gives details of three second generation populations 2a, 2b and 2c.

TABLE 5

| 2a | Order | N8 | N6 | N2 | N5 | N7 | N4 | N3 |
|---|---|---|---|---|---|---|---|---|
| | Fit | 0.727 | 0.000 | 0.000 | 0.000 | 0.009 | 0.264 | 0.000 |
| | ICFm | 0.068 | 0.200 | 0.290 | 0.873 | 0.790 | 0.320 | 0.201 |
| | Random1 | 0.605 | 0.175 | 0.781 | 0.163 | 0.869 | 0.191 | 0.695 |
| | IsLeak | Y | | Y | | Y | | Y |
| | Ramdom2 | 0.232 | 0.091 | 0.358 | | 0.769 | | 0.542 |
| | Prob | 0.216 | 0.073 | 0.254 | | 0.161 | | 0.433 |
| | Burst | 2.581 | 3.311 | 2.375 | | 1.124 | | 2.532 |
| | Remain | 11.924 | 3.311 | 9.343 | | 6.967 | | 5.843 |
| 2b | Order | N8 | N6 | N2 | N5 | N7 | N4 | N3 |
| | Fit | 0.727 | 0.000 | 0.000 | 0.000 | 0.009 | 0.264 | 0.000 |
| | ICFm | 0.068 | 0.200 | 0.290 | 0.873 | 0.790 | 0.320 | 0.201 |
| | Random1 | 0.796 | 0.329 | 0.302 | 0.767 | 0.756 | 0.508 | 0.217 |
| | IsLeak | Y | Y | Y | | | Y | Y |
| | Ramdom2 | 0.980 | 0.134 | 0.881 | | | 0.730 | 0.279 |
| | Prob | 0.913 | 0.108 | 0.626 | | | 0.496 | 0.223 |
| | Burst | 10.886 | 0.112 | 0.580 | | 0.136 | 0.172 | 0.039 |
| | Remain | 11.924 | 1.038 | 0.926 | | 0.136 | 0.346 | 0.175 |
| 2c | Order | N8 | N3 | N7 | N6 | N5 | N2 | N4 |
| | Fit | 0.727 | 0.000 | 0.009 | 0.000 | 0.000 | 0.000 | 0.264 |
| | ICFm | 0.068 | 0.201 | 0.790 | 0.200 | 0.873 | 0.290 | 0.320 |
| | Random1 | 0.102 | 0.899 | 0.227 | 0.780 | 0.942 | 0.344 | 0.427 |
| | IsLeak | Y | Y | | Y | Y | Y | Y |
| | Ramdom2 | | 0.109 | | 0.716 | 0.942 | 0.539 | 0.159 |
| | Prob | | 0.087 | | 0.573 | 0.120 | 0.382 | 0.090 |
| | Burst | | 1.039 | 2.302 | 6.233 | 0.557 | 1.566 | 0.227 |
| | Remain | | 11.924 | 2.302 | 10.884 | 4.651 | 4.094 | 2.529 |

Referring first to population 2a, it will be seen that the node order is exactly the same as that of the best fit population 1b from the first generation. It will also be seen that the fit values calculated as mentioned above are indicated in the fit row. These fit values are used to influence the subsequent allocation of bursts by modifying the ICF of respective nodes. Specifically, the fit value is substrated from 1 and the remainder is used as a modifier which is multiplied together with the nodal ICF to give a modified ICF value indicated in the row “ICFm”. Otherwise the procedure for generating the burst population is the same as for the first generation. It will, however, be appreciated that bursts are weighted towards those nodes having bursts in the best fit population of the previous generation by reduction of the respective ICF values and that furthermore the weighting is related to the size of burst allocated to each node in the best fit population.

Population 2b is generated in the same way as population 2a. Population 2c is generated in the same way as populations 2a and 2b except in this instance it will be noted that the node order is randomly generated rather than node carried over from the best fit of generation 1. This is done to introduce a random element into the process which reduces the likelihood of arriving at a solution which is effectively a local minima.

Having generated the three populations of the second generation a hydraulic analysis can then be performed on each population and the best fit selected under the criteria mentioned above. New fit values are generated on the basis of the second generation of the best fit population which are then carried over to a third generation together with a best fit node order. Third and subsequent generations can then be generated on the same basis as the second generation until no significant improvement is found from one generation to the next in the fit of the best fit burst allocations. The final best fit population is then taken as the solution.

It will be appreciated that there may be many variations of the precise manner of performing the method simplified above. For instance, the various steps of generating each population do not have to be performed sequentially as described. For example in the first generation the node order information is not required until the burst leakage allocation step and can be generated at that time.

The random numbers “random 1” and “random 2” are calculated between 0 and 1 since this is the full range of possible ICFs in accordance with the calculation made earlier in the description. It is of course entirely possible that the ICF range differs from that used in this example and thus that the random ranges will differ accordingly. It will also be readily apparent that the precise arithmetic operations may vary. For instance, ICF values may be established on a different basis from that used above. For example, ICF values could be calculated on a basis which gives a low ICF for a pipe in good condition with low burst probability.

ICF values could also be modified to take account of the certainty or otherwise of the information used to generate those values. For instance the age of a particular pipe might not be known in which case it might be necessary to estimate the age, perhaps on the basis of the age of a related node. Each ICF could therefore be multiplied by a probability factor (eg between 0 and 1) based on the expected accuracy of the information used to calculate the ICF.

The burst allocation process could be run without any modification based on ICF values. For instance, the burst leakage allocation in the first generation of populations could be generated on a purely random basis and best fit information carried over to subsequent generations and used to modify the random number elements such as random 1 and random 2. Use of ICF values is however a much preferred method as it gives a systematic weighting taking into account the condition of pipe work.

In the first generation of populations pipe ordering for each population is randomly generated. An alternative might be to generate a separate population for each possible pipe order. Similarly, initial leak allocation (see the “is leak” column of the above tables) is made on the basis of the ICF and a randomly generated number. This could alternatively be made solely on the basis of the ICF values, or alternatively could be made purely randomly. In an extreme example a separate population could be generated for each possible distribution of leaks for any given pipe order.

Similarly, the calculation of the probability factor “Prob” could be made purely on the basis of the ICF value rather than the ICF value as modified by a randomly generated number (random 2).

The residual burst leakage remaining after allocation has been made to all nodes in a population deemed to have a burst could be made in a different manner from that described. In the above example the residual burst is allocated to a single node but could for instance be split between all nodes not already allocated with a burst.

The manner in which the normalised “fit” value is determined could be varied.

It will also be appreciated that the number of populations in any given generation could be varied and need not be the same in each successive generation. It is envisaged that for a typical-network DMA, and applying the method as described in detail above, that of the order of fifty populations per generation would give good results.

The random element introduced into each generation can vary. In the above example one population out of three in the second and subsequent generations is based on a new random pipe order (although including fit values from the previous generation best fit population). This ratio could vary. Moreover, random solutions could be introduced by including populations in second and subsequent generations that do not take account of the fit information.

From the above paragraphs it will be gathered that a number of changes could be made to the detailed processes outlined in the example. Having said that, all of the processes mentioned in the example are preferred. For instance, if all of the possible modifications indicated above are made the resultant method might require a very large number of generations to arrive at a best fit solution, and indeed the number of generations required might be completely impractical. The various preferred features of the method mentioned above help streamline the process and improve its overall accuracy.

A further aspect of the present invention is that once burst and background leakage has been allocated in accordance with the preferred methods described above, calibration of the network model as a whole is improved over that achieved using conventional techniques. Thus, ultimately the present invention provides a method which provides improved calibration of a pipe network model.

It will be appreciated that the various aspects of the present invention need not necessarily be combined. For instance, the burst allocation method could be used in conjunction with alternative methods of determining the overall volumes of burst leakage and allocation of background leakage. Similarly, the preferred methods for determining the ratio of background to burst leakage could be used in other methods of identifying individual bursts. The proposed method representing the likelihood of any given pipe experiencing a burst by generation of ICF values could be used in other methods of calibrating a pipe network. In other words, the various aspects of the present invention are particularly advantageous when used together but could nevertheless be used independently in conjunction with other conventional methods.

It will also be appreciated that the present invention is not limited to analysis of water pipe networks but rather can be applied to any network of fluid conduits in which leakage may be expected to occur.

Other possible modifications and applications of the present invention will be readily apparent to the appropriately skilled person

1. A method of dividing the total leakage losses of a pipe network into intrinsic background leakage and burst leakage, the method comprising:
defining a first infrastructure condition factor (ICF) which is a numerical representation of the condition of a network in a threshold good condition in which intrinsic background leakage can assumed to be a negligible proportion of the total network leakage losses;
defining a second ICF which is a numerical representation of the condition of a network in a threshold poor condition in which intrinsic background leakage dominates total leakage losses;
deriving a network ICF for the network under consideration which expresses the condition of the network as a numerical fraction of the difference between the first and second ICFs;
determining total leakage losses from the network by performing a network analysis on the network;
and multiplying the total leakage losses by the network ICF to divide the total leakage losses into intrinsic background and total network burst leakage.

2. The method according to claim 1, wherein the total leakage loss is multiplied by the network ICF to directly give the level of burst or background leakage respectively dependent upon whether the first ICF is defined to be higher than the second ICF or vice versa, the remainder being taken as the background or burst leakage respectively.

3. The method according to claim 1 or claim 2, wherein the network ICF is derived by determining a pipe ICF for each pipe in the network model which is a numerical expression of the expected proportional split of leakage between background leakage and burst leakage in a theoretical network comprising pipes all having that ICF, and averaging the pipe ICF values across the network to give the network ICF.

4. A method according to claim 3, wherein said averaging is performed by first length weighting each of the pipe ICFs by multiplying each pipe ICF by the length of the respective pipe, summing the length weighted pipe ICFs of all pipes within the network, and dividing the sum of length weighted pipe ICFs by the total length of the pipe within the network to give said network ICF.

5. A method according to claim 4, wherein the pipe ICF of each individual pipe within the network is derived on an empirical basis as a function of one or more of the age, material, number of pipe joints and fittings, and ground conditions attributable to the respective pipe.

6. A method according to any preceding claim, further comprising determining the most likely size and location of burst in the pipe network by:
generating a first generation of bursts populations in each of which the total burst leakage is distributed amongst nodes of the network model;
performing a network analysis on the network model for each of the burst populations, the network analysis being conducted in each case on the basis of the respective distribution of bursts across the network;
comparing operating parameters of the network determined by the network analysis for each burst population with measured values of said operating parameters to determine a best fit burst population for which the operating parameter values determined by the network analysis best match the measured values;
generating second and subsequent generations of burst populations, the distribution of bursts in at least some of the burst populations of each generation being weighted in accordance with the burst distribution of the best fit population of the previous burst generation;
performing the network analysis and best fit comparison on each generation and continuing until subsequent generations show no significant improvement in best fit burst population.

7. A method according to claim 6, wherein at least some of the burst populations of the second and each subsequent generation of burst populations are generated without weighting in accordance with the previous best fit burst population.

8. A method according to claim 6 or claim 7, wherein the distribution of total burst leakage within each burst population of each generation is weighted in accordance with a nodal infrastructure condition factor (ICF) representative of the relative condition of each node and indicative of the likelihood of a burst being associated with that node.

9. The method according to claims 8, wherein the nodal ICF of each node in the network is determined by dividing the sum of length weighted ICFs of each pipe converging at the respective node by the total length of the pipes converging at that node.

10. The method according to claim 8 or claim 9, wherein the distribution of total burst leakage within each burst population is weighted in accordance with the nodal ICF by the following procedure;
generating a first random number for each node which lies within the range of. possible nodal ICF values;
comparing the first random number with the ICF of the respective node and allocating a burst to that node if the first random number is greater than or less than the ICF depending on whether the ICF values are defined such that higher values represent better condition networks or vice versa.

11. The method according to claim 10, wherein the nodal ICF is used to weight both the distribution of bursts across nodes in a particular burst population and also the size of burst allocated to each node of that population.

12. The method according to claim 11, wherein the size of bursts allocated to particular nodes is determined by the following procedure:
multiplying the difference between the nodal ICF of a respective node and the maximum ICF possible for a node by a second random number between 0 and 1 to define a burst probability factor;
considering a first node to which a burst has been allocated and multiplying the total burst leakage for the network by the probability factor derived for that node to determine the size of burst to be allocated to that node;
considering a second node to which a burst has been allocated and multiplying the remaining unallocated burst leakage by the burst probability factor of that node to determine the size of burst to be allocated to that node;
repeating the above process for each node to which a burst has been allocated until the size of the allocated bursts for all such nodes has been determined; and
allocating the remaining unallocated burst leakage randomly to at least one of the nodes not originally allocated a burst.

13. A method according to claim 12, wherein the order in which the nodes are considered for determination of burst sizes is randomly determined for at least some populations of each generation of populations.

14. A method according to any one of claims 8 to 13, wherein the weighting of the burst distribution within burst populations of the second and subsequent generations on the basis of the previous best fit burst population is achieved by modifying the nodal ICF of each node within a population in accordance with the relative distribution of bursts across respective nodes of the previous best fit population.

15. The method according to claim 14, wherein a fit value is derived for each node allocated a burst in the previous best fit burst population by dividing the burst leakage allocated to a particular node by the total burst leakage for the network, and modifying the ICF of a respective node as a function of the fit value.

16. The method according to claim 15, wherein the fit value for a node is subtracted from one and the remainder used as a modifier which is multiplied together with the nodal ICF of the respective node to give a modified ICF for that node, the modified ICF being used in place of the original ICF in the subsequent burst allocation procedures.

17. A method according to any one of claims 12 to 16, wherein the order in which nodes are considered for determination of burst sizes for at least some of the burst populations of the second and subsequent generations corresponds to the order of nodes from the previous best fit population.

18. The method according to any one of claims 8 to 17, wherein when performing the network analysis the total background leakage is distributed amongst nodes of the network.

19. The method according to claim 18, wherein the background leakage is allocated to nodes of the network as a function of the user demand at each node of the network.

20. The method according to claim 19, wherein the total background leakage is allocated to nodes of the network in accordance with the following procedure:
dividing the demand associated with the node by the nodal ICF to derive a nodal leakage factor (LF);
multiplying the nodal LF by the total background leakage for the network and dividing by the sum of the nodal LFs of all nodes within the network.

21. A method of calibrating a pipe network model by determining burst and background leakage distribution in accordance with any preceding claim.

22. A method determining the most likely size and location of bursts in a pipe network, the method comprising:
determining the total burst leakage associated with the network by network analysis on a model of the network;
generating a first generation of bursts populations in each of which the total burst leakage is distributed amongst nodes of the network model;
performing a network analysis on the network model for each of the burst populations, the network analysis being conducted in each case on the basis of the respective distribution of bursts across the network;
comparing operating parameters of the network determined by the network analysis for each burst population with measured values of said operating parameters to determine a best fit burst population for which the operating parameter values determined by the network analysis best match the measured values;
generating second and subsequent generations of burst populations, the distribution of bursts in at least some of the burst populations of each generation being weighted in accordance with the burst distribution of the best fit population of the previous burst generation;
performing the network analysis and best fit comparison on each generation and continuing until subsequent generations show no significant improvement in best fit burst population.

23. The method according to claim 22, further comprising with features of any one of claims 7 to 20.

24. The method of allocating intrinsic background leakage across the nodes of a pipe network model, the method comprising:
determining the total background leakage of the network;
determining the user demand at each node of the network;
determining a nodal infrastructure condition factor (ICF) for each node representative of the relative condition of each node;
dividing the demand associated with each node by the nodal ICF of that node to derive a nodal leakage factor (LF);
and multiplying the nodal LF by the total background leakage for the network and dividing by the sum of the nodal LFs of all nodes within the network to determine the background leakage to be allocated to that node.

25. The method according to claim 24, wherein the nodal ICF is values are derived by determining a pipe ICF for each pipe in the network model which is a numerical expression of the expected proportional split of leakage between background leakage and burst leakage in a theoretical network comprising pipes all having that ICF, length weighting each of the pipe ICFs by multiplying each pipe ICF by the length of the respective pipe, and dividing the sum of length weighted ICFs of each pipe converging at the respective node by the total length of the pipes converging at that node.

26. A method according to claim 25, wherein the pipe ICF of each individual pipe within the network is derived on an empirical basis as a function of one or more of the age, material, number of pipe joints and fittings, and ground conditions attributable to the respective pipe.

27. A computer programme for carrying out a method according to any preceding claim.

28. A carrier medium carrying computer readable code for causing a computer to execute procedure according to the method of any one of claims 1 to 26.
